(19) United States
(12) Patent Application Publication
(10) Pub. No.: US 2009/0083832 A1
(43) Pub. Date: Mar. 26, 2009

(54) Modal and linear techniques for access control logic

(75) Inventors: Martin Abadi, Palo Alto, CA (US); Deepak Garg, Pittsburgh, PA (US); David E. Langworthy, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/903,076

(22) Filed: Sep. 20, 2007

(51) Int. Cl. H04L 9/32; G06F 17/00

(52) U.S. Cl. 726/2; 706/47

(57) ABSTRACT

Access control logic may use logical constructs such as “says” and “speaks for”, and may be translated to modal logic. The modal logic may be used to determine the truth or falsehood of formulas in access control logic, which may be used in access control decisions. The modal logic may be S4, and access control logic, including “says” and “speaks for”, may be translated into S4. Linear logic may be used to guarantee separation of duty in access control.

### BACKGROUND

Access control is directed to determining whether a principal that issues a request may be trusted on this request. For example, a principal may be a process running on behalf of a user, and the request may be a command to read a particular file. An access control mechanism would determine whether the read may be permitted. An authorization decision may rely on consulting an access control matrix that would map the user's name and the file name to a set of allowed operations. The matrix may be implemented in terms of access control lists (ACLs), attached to objects, or in terms of capabilities. Typically, however, the authorization decision is considerably more complex. It may depend, for example, on the user's membership in a group, and on a digitally signed credential that certifies this membership.

Access control is central to security and is pervasive in computer systems. It appears in many applications, virtual machines, operating systems, and-firewalls. Physical protection for facilities and for hardware components are other forms of access control.

Although access control may seem conceptually straightforward, it is both complex and error-prone. The mechanisms for access control are often broken or circumvented.

### SUMMARY

Access control logic may use logical constructs such as “says” and “speaks for”, and may be translated to modal logic. The modal logic may be used to determine the truth or falsehood of formulas in access control logic, which may be used in access control decisions. The modal logic may be S4, and access control logic, including “says” and “speaks for”, may be translated into S4.

Connectives from linear logic may be used to guarantee separation of duty in access control. For separation of duty, each expression of authority may be expressed as an implication. Rights are resources that can be consumed. When the right to exercise an authority is used, it may not be used again for the same purpose or a different purpose. When an access control request is received, it may be determined whether the request may be granted or not, based on a proof constructed in linear logic that may be dependent on the principal having the authority to act. If the principal has authority to act (e.g., has an unconsumed resource), the request may be granted.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 is a block diagram of an implementation of a system that may be used for access control;

FIG. 2 is an operational flow of an implementation of a method of access control;

FIG. 3 is a block diagram of another implementation of a system that may be used for access control;

FIG. 4 is an operational flow of another implementation of a method of access control; and

FIG. 5 is a block diagram of an example computing environment in which example embodiments and aspects may be implemented.

### DETAILED DESCRIPTION

Access control is directed to determining whether a principal that issues a request may be trusted on this request. Logics for access control enable reasoning about principals, their requests, and other statements. Access control may be provided with logics using logical operators such as “says” and “speaks for”.

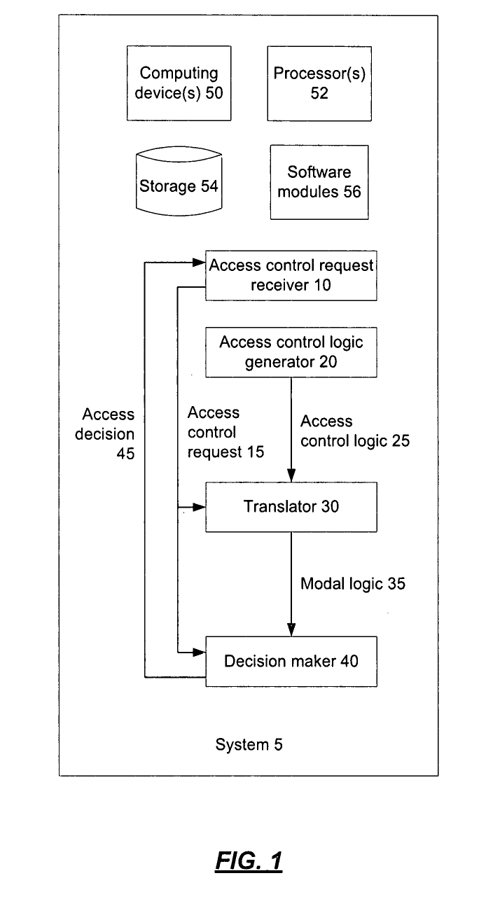

FIG. 1 is a block diagram of an implementation of a system that may be used for access control. A system 5 may include an access control logic generator 20 and a translator 30. The access control logic generator 20 may generate access control logic 25, as described further herein. The access control logic 25 may then be provided to a translator 30, which may translate the access control logic 25 into modal logic 35, such as S4 or any other modal logic.

In an implementation, the system 5 may include an access control request receiver 10 and a decision maker 40. The access control request receiver 10 may receive a request for access, e.g., from a process running within the system 5, and may pass an access control request 15 to the decision maker 40. Alternatively, the access control request 15 may be translated to modal logic prior to being provided to the decision maker 40. In such a case, the access control request 15 may be provided to the translator 30, which may translate the access control request 15 into modal logic 35. The decision maker 40 may evaluate the truth or falsehood of the modal logic 35 underlying the access control request 15, and may provide an access decision 45 back to the access control request receiver 10, as described further herein.

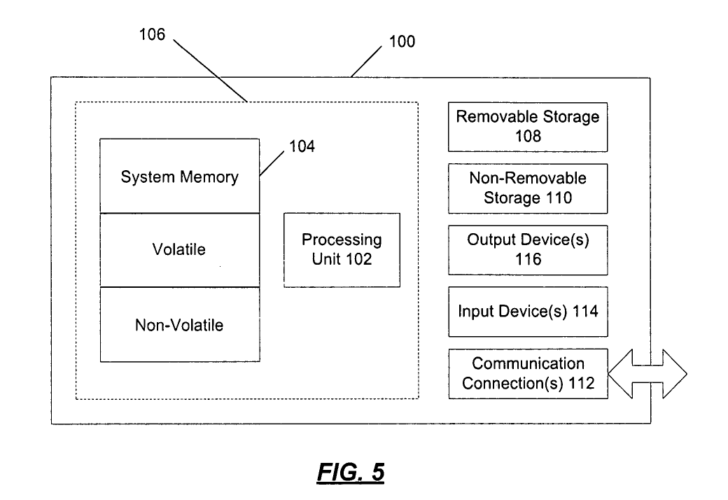

The system 5 may include one or more computing devices, although only one computing device 50 is shown in FIG. 1. Each computing device 50 may have one or more processors 52, storage 54 (e.g., storage devices, memory, etc.), and software modules 56. The computing device 50, including its processor(s) 52, storage 54, and software modules 56, may be used in the performance of the example methods described herein. Example software modules may include modules for receiving and acting on an access control request, storing and retrieving access control logic and modal logic, and providing a decision in response to the access control request, described further herein. While specific functionality is described herein as occurring with respect to specific modules, the functionality may likewise be performed by more, fewer, or other modules. The functionality may be distributed among more than one module. An example computing device and its components are described in more detail with respect to FIG. 5.

The logics for access control may include formulas such as “A says s”, where A represents a principal, s represents a statement (e.g., a request for an operation, a delegation of authority, some other utterance, etc.), and says is an operator. The use of says may abstract from details of authentication and authorization. Thus, in an implementation, an intuitionistic logic may be extended with the formula “A says s”.

It may be asserted that A says s even when A does not directly produce or utter s. For example, when A is a user and one of its programs sends or includes s in a message, it may be convenient and accurate to state that A says s, although A itself may never have even seen s. In such an implementation, A says s may mean that A has caused s to be said, or that s has been said on A's behalf, or that A supports s.

If A says s and A speaks for another principal B, then B says s. The relation “speaks for” may serve to form chains of responsibility in implementations. A program may speak for a user, like a key may speak for its owner, or like a channel may speak for its remote end-point. Therefore, some logics may include “speaks for” as an operator.

In logical approaches to access control, techniques may be used that determine whether or not a formula is true. A problem of determining whether an operation may be granted may be formulated in logical terms, as a problem of constructing or checking a proof.

In an implementation, a logical formula s may represent that a particular operation o may be performed. In such a case, s may be written as a proposition of the form Do(o). A decision maker in charge of making access control decisions for o may have the policy that a particular principal A is authorized to perform o. This policy may be represented by the formula (A says Do(o))→Do(o), where “→” represents “implies”. Similarly, a request for the operation o from a principal B may be represented by the formula B says Do(o). The decision maker may attempt to prove that these two formulas imply Do(o), and grant access if it succeeds. In general, a proof may exploit relations between A and B and other facts known to the decision maker. Alternatively, the decision maker may check a proof presented by B.

Modal logic is a well known logic for handling concepts like possibility, existence, and necessity. As described further herein, access control logic may be translated to modal logic.

A basic modal operator is “necessarily”, which may be stated as “it is necessary that” and may be denoted as a box [ ]. A necessitation rule, N, provides that if p is a theorem of a system, then [ ]p is likewise a theorem. According to the necessitation rule, any theorem of logic is “necessary”. A distribution axiom, K, provides that [ ](p→q)→([ ]p→[ ]q). The distribution axiom holds that if it is necessary that if p then q, then if necessarily p then necessarily q.

A reflexivity axiom, T, provides [ ]p→p, which holds that if p is necessary, then p is the case. A “4” axiom provides [ ]p→[ ][ ]p. As a result, any string of boxes may be replaced by a single box. This leads to the idea that iteration of the modal operators is superfluous. For example, stating that p is necessarily necessary is considered the same as stating that p is necessary. These particular axioms are adopted in some but not all modal logics, and other axioms are possible as well. Each modal logic typically has its own specific set of axioms.

An example modal logic system is the well known S4 modal system that is based on the N, K, T, and 4 axioms. Modal logic S4 is an extension of classical logic with the additional connective [ ]s. Proof-theory and model-theory of S4 are well known.

Access control logic may be translated to modal logic. The modal logic may determine whether something is true or false and may be used to make access control decisions. The modal logic may be used to create proofs. Translation to modal logic and the use of models of modal logic may be used to provide counterexamples.

In an implementation, access control logic may be translated to S4 which has known decision procedures. These decision procedures may be used to evaluate the truth or falsehood of formulas in access control logic.

Translation may be provided from an access control logic with a says modality to modal logic S4. In an implementation, access control logic, including the “says” and “speaks for” constructs, may be translated into S4. A translation may be described that translates logics with “says” and “speaks for” to S4. In an implementation, A says s, which means that principal A supports statement s, may be translated as [ ] (A or s′), where in turn s′ is the translation of s. A speaks for B, which means that if A says something then B says it as well, may be translated as [ ] (A implies B). Note that although the something being said may be arbitrary, a quantification over all possible statements in the translation is not required. Quantification is a common source of undecidability.

Because S4 is decidable, techniques for S4 may be applied to establish the validity of a formula in the logic of access control. In addition, there is a notion of model of S4, with the property that if a formula is not valid in S4 then there is a model in which it is not true. Models may be finitely represented. Therefore, when a formula in access control logic is not valid, a model may be provided in which its S4 translation is false. This model might be presented by a client to a server in order to show that it does not have a certain property or right, or it might be presented by a server to a client as an explanation for why a right is denied.

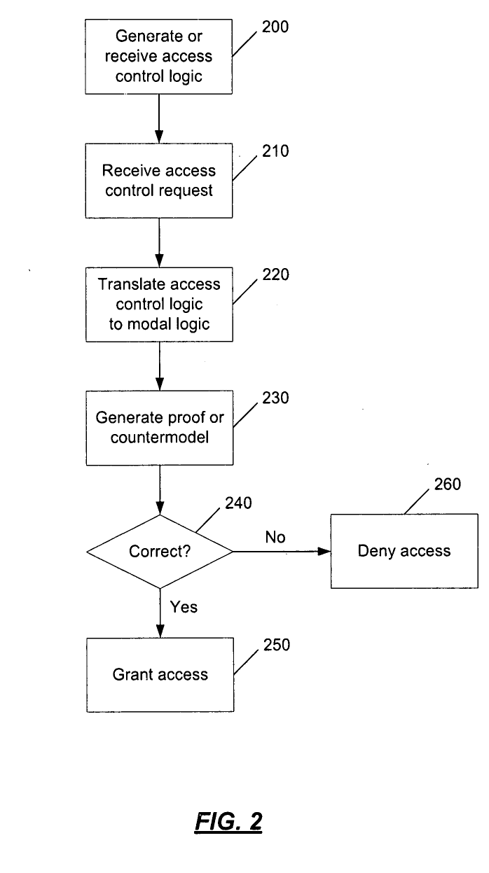

FIG. 2 is an operational flow of an implementation of a method of access control. At operation 200, access control logic may be generated or received. In an implementation, a formula or set of formulas in access control logic that express a security policy and various known credentials may be generated or received. At some point, at operation 210, an access control request pertaining to the access control logic may be received. The access control logic may be translated into modal logic, such as S4, at operation 220. The modal logic, using known techniques, may be used to generate a proof or countermodel, operation 230.

The proof or countermodel may be determined to be correct, at operation 240. In other words, the correctness of the proof or countermodel may be determined. If correct, then access may be granted, at operation 250. Otherwise, access may be denied, at operation 260.

In an implementation, the translation [symbol] x [symbol] from access control logic, with says and speaks for, to S4 may be defined by induction on the structure of formulas. For atomic formulas and non-modal connectives, in which [symbol] =conjunction (AND), [symbol] =disjunction (OR), →=implication, T=true, and ⊥=false, the translations may be given as: [symbol] p [symbol] =[ ]p, [symbol] s [symbol] t [symbol] = [symbol] s [symbol] [symbol] [symbol] t [symbol] , [symbol] [symbol] s [symbol] t [symbol] = [symbol] s [symbol] [symbol] [symbol] t [symbol] , [symbol] s→t [symbol] =[ ]( [symbol] s [symbol] → [symbol] t [symbol] ), [symbol] T [symbol] =T [symbol] ⊥ [symbol] =⊥, and [symbol] A says s [symbol] =[ ](A [symbol] [symbol] s [symbol] ).

In the translation of A says s, the principal A may be interpreted as an atomic formula in S4. The translation of A says s may be [ ] (A [symbol] translation of (s)), and the translation of A speaks for B may be [ ] (A→B).

For translation to modal S4, in the definition [symbol] A says s [symbol] =[] (A [symbol] [symbol] s [symbol] ), A may be interpreted as a formula in S4. Each Boolean connective in A may be mapped to the corresponding connective in S4, and any atomic principals in A may be read as atomic formulas. For example, the formula (Bob→admin) says deletefile1 translates to [ ]((Bob→admin) [symbol] [ ]deletefile1).

Decision procedures for S4 are well known, and after the access control logic is translated into S4, decisions may be made on the S4 using known procedures.

Regarding “Boolean principals”, past work considered compound principals of the form “A and B” and “A or B”. Here “A implies B” may be provided, with the meaning that “(A implies B) says s” if A speaks for B on s and its consequences. The use of “implies” on principals may be of independent value.

Boolean connectives in principals are as follows.

(A [symbol] B) says s means that A says s and B says s. (A [symbol] B) says s means that by combining what A and B assert, s may be concluded. Disjunction of principals may be used to model groups in access control.

(A→B) says s means that A speaks for B on s and its consequences. It may be shown that if (A→B) says s and s→s′, then A says s′→B says s′. In access control, this models delegation of rights from B to A.

T says s is vacuously true because T says ⊥. In access control, T may be used to model an intruder or malicious principal. ⊥ says s implies that s is true. ⊥ is a trustworthy principal. It may be viewed as the administrator or local authority at the site of access control.

Some access control policies that require controlled, limited use of authority are difficult to express and support with logical approaches. An example of such a policy is one that requires separation of duty, e.g., one that allows anyone with the role of “CEO” and anyone with the role of “Doctor” to fire an employee, provided the CEO and the Doctor are different individuals. In previous approaches, the separation requirement was difficult or not possible to express and enforce.

Logic with linearity constraints, also referred to as linear logic, may be used to express separation of duty. Linear logic is a well known refinement of classical and intuitionistic logic. Instead of emphasizing truth, as in classical logic, or proof, as in intuitionistic logic, linear logic emphasizes the role of formulas as resources. The interpretation of hypotheses is as resources: every hypothesis is consumed exactly once in a proof. It is also possible to formulate a variant of linear logic, known as affine logic, in which every hypothesis is consumed at most once.

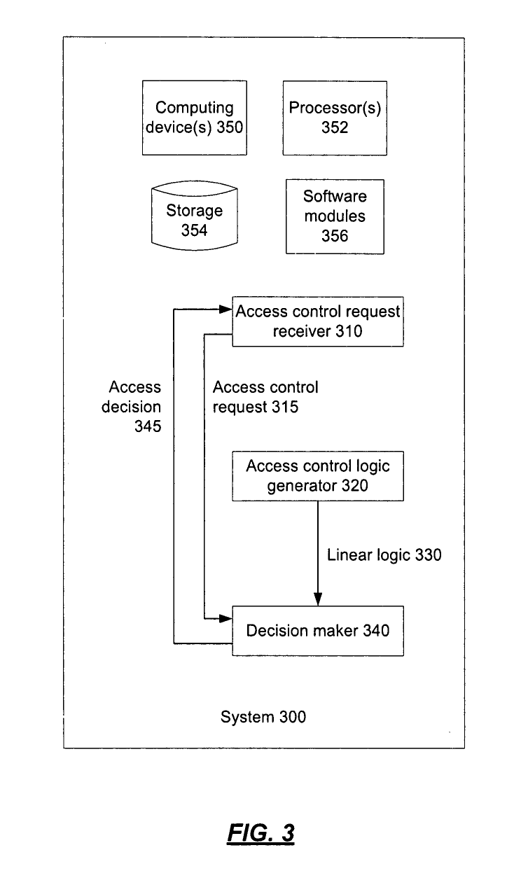

FIG. 3 is a block diagram of another implementation of a system that may be used for access control. A system 300 may include an access control logic generator 320 that generates access control logic using linear logic 330, as described further herein. The linear logic 330 may be provided to a decision maker 340 that evaluates the truth or falsehood of the linear logic 330.

In an implementation, the system 300 may include an access control request receiver 310. The access control request receiver 310 may receive a request for access, e.g., from a process running within the system 300, and may pass an access control request 315 to the decision maker 340. Access control decisions, and separation of duty decisions, may be made based on the truth or falsehood of the linear logic 330 in view of the access control request 315. An access decision 345 may be generated by the decision maker 340 and provided to the access control request receiver 310.

As with the system 5 of FIG. 1, the system 300 may include one or more computing devices, although only one computing device 350 is shown in FIG. 3. Each computing device 350 may have one or more processors 352, storage 354, and software modules 356 that may be used in the performance of the example methods described herein. Example software modules may include modules for receiving and acting on an access control request such as a separation of duty request, storing and retrieving access control logic and linear logic, and providing a decision in response to the access control request, described further herein. While specific functionality is described herein as occurring with respect to specific modules, the functionality may likewise be performed by more, fewer, or other modules. The functionality may be distributed among more than one module. An example computing device and its components are described in more detail with respect to FIG. 5.

Linear logic may be considered to be a type of logic in which an inference expends the premises that enabled it. For example, a proof constructed in linear logic that a client's job is safe to execute, which is dependent on the client having the authority to act, would consume the authority resources. Once the authority is used in a proof, it is consumed, thus making it unavailable for use in future proofs.

Each logical connective in linear logics splits into multiplicative and additive versions, which correspond to simultaneous and alternative presence, respectively. Logical connectives include multiplicative conjunction, additive conjunction, multiplicative disjunction, and additive disjunction.

Multiplicative conjunction, also called “tensor” or “times” (written [symbol] ), denotes simultaneous occurrence of resources, to be used as the consumer directs. [symbol] is an associative and commutative operation. The constant 1 is used to denote the absence of any resource; it functions as a unit of tensor: A [symbol] 1≡1 [symbol] A≡A.

Additive conjunction, also called “with” (written &) represents alternative occurrence of resources, the choice of which a user may control. This operation is also both associative and commutative. Additive conjunction has a unit top (written T, with A & T≡T & A≡A); it represents a lack of alternative or an inability to choose. It is often used when the exact accounting of resources is burdensome or impossible. This unit may be used together with [symbol] to define a minimal composition of resources.

Additive disjunction, also called “plus” (written ⊕) represents alternative occurrence of resources, the choice of which the producer controls. Once again, this operation is associative and commutative. Its unit is the constant 0, which represents a lack of outcome, catastrophic failure, or inability of the producer to comply with its programming.

Linear implication may also be provided, as the conjunctions and disjunctions define the state of the world, but the description is static. For state change, linear logic defines the connective of linear implication (written −o). As a resource, A −o B means a method to consume resource A to achieve resource B. Note that the implication itself is a resource that must obey the principle of single consumption. It is also noted that A −o B itself may be a resource.

Exponential connectives may also be used, as the collection of connectives so far may describe states and transitions, but may be too weak if one needs the usual notion of truth. Linear logic may use an idea from modal logic to embed the usual logic by means of a pair of exponential operators.

Re-use or copying is allowed for propositions using an “of course” exponential operator (written !). Logically, two occurrences of !A as hypotheses may be contracted into a single occurrence. This is related to the conjunctions in that the user has the power to decide how often A will appear.

The collection of goals is allowed to be extended with propositions using a “why not” operator (written ?). Logically, any fact can be weakened by including an additional conclusion ?A. This is related to the disjunctions in that the producer has the power to decide how often A will appear. Under the resource interpretation, ! may encode arbitrary production and ? may encode arbitrary consumption.

The connectives from linear logic may be used to guarantee separation of duty in access control. For example, without linear logic, the operator=>may be used as a means of expressing that one authority is at least as strong as another, e.g., Bob=>CEO and Bob =>Doctor mean that Bob can act as CEO and as Doctor. In this example, =>is the “speaks for” operator, and it may be identified with the “can act as” relation. Without linear logic, it follows that Bob=>(CEO and Doctor). With linear logic, however, linear implications may be used: Bob −o CEO and Bob −o Doctor. This formulation has the property that Bob's authority can be used as CEO or as Doctor, whichever Bob wishes, but not both at the same time.

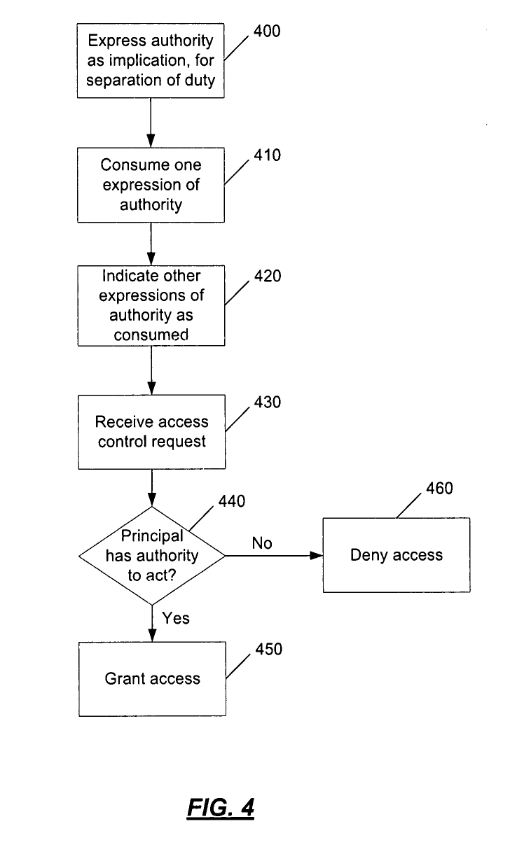

FIG. 4 is an operational flow of another implementation of a method of access control. At operation 400, for separation of duty, each expression of authority may be expressed as an implication, e.g., with the implication operation −o. When one of the expressions of authority is consumed for a principal (e.g., Bob −o CEO), at operation 410, the other expressions of authority pertaining to that principal may also be considered to be consumed (e.g., Bob −o Doctor) and may be marked, flagged, or otherwise indicated as consumed, at operation 420.

At some point, at operation 430, an access control request may be received that may be directed to an expression of authority. At operation 440, it may be determined whether the request may be granted or not, based on a proof constructed in linear logic that is dependent on the principal having the authority to act. If the principal has authority to act (e.g., has an unconsumed resource), the request may be granted, at operation 450. Otherwise, the request may be denied, at operation 460.

In this manner, it may be determined whether an expression of authority may give privileges or has already been consumed and may not give privileges, in response to an access control request. Thus, separation of duty in access control may be properly implemented.

### Exemplary Computing Arrangement

FIG. 5 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 100. In its most basic configuration, computing device 100 typically includes at least one processing unit 102 and memory 104. Depending on the exact configuration and type of computing device, memory 104 may be volatile (such as random access memory (RAM)), non-volatile (such as read-only memory (ROM), flash memory, etc.), or some combination of the two. This most basic configuration is illustrated in FIG. 5 by dashed line 106.

Computing device 100 may have additional features/functionality. For example, computing device 100 may include additional storage (removable and/or non-removable) including, but not limited to, magnetic or optical disks or tape. Such additional storage is illustrated in FIG. 5 by removable storage 108 and non-removable storage 110.

Computing device 100 typically includes a variety of computer readable media. Computer readable media can be any available media that can be accessed by device 100 and includes both volatile and non-volatile media, removable and non-removable media.

Computer storage media includes volatile and non-volatile, removable and non-removable media implemented in any method or technology for storage of information such as computer readable instructions, data structures, program modules or other data. Memory 104, removable storage 108, and non-removable storage 110 are all examples of computer storage media. Computer storage media includes, but is not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of computing device 100.

Computing device 100 may contain communications connection(s) 112 that allow the device to communicate with other devices. Computing device 100 may also have input device(s) 114 such as a keyboard, mouse, pen, voice input device, touch input device, etc. Output device(s) 116 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. An access control system, comprising:
a translator that receives access control logic and translates the access control logic into modal logic; and
a decision maker that determines whether access control may be granted based on the modal logic.

2. The system of claim 1, wherein the modal logic is modal logic S4.

3. The system of claim 1, wherein the access control logic comprises at least one of a says operator or a speaks for operator.

4. The system of claim 3, wherein the says operator or the speaks for operator is translated into modal logic comprising a necessarily modal operator.

5. The system of claim 1, wherein the access control logic comprises a formula of the form A says s, where A represents a principal, s represents a statement, and says is an operator.

6. The system of claim 1, wherein the decision maker evaluates the truth or falsehood of the modal logic.

7. An access control method, comprising:
translating access control logic into modal logic; and
determining whether access control may be granted based on the modal logic.

8. The method of claim 7, wherein the modal logic is modal logic S4.

9. The method of claim 7, wherein the access control logic comprises at least one of a says operator or a speaks for operator.

10. The method of claim 9, wherein the says operator or the speaks for operator is translated into modal logic comprising a necessarily modal operator.

11. The method of claim 7, wherein the access control logic comprises a formula of the form A says s, where A represents a principal, s represents a statement, and says is an operator.

12. The method of claim 11, wherein the principal is a Boolean principal.

13. The method of claim 7, wherein determining whether access control may be granted comprises evaluating the truth or falsehood of the modal logic.

14. The method of claim 7, wherein determining whether access control may be granted comprises generating a proof or countermodel and evaluating the correctness of the proof or countermodel.

15. The method of claim 14, wherein if the proof or countermodel is correct then granting access and otherwise denying access.

16. The method of claim 7, further comprising receiving the access control logic responsive to an access control request.

17. An access control method, comprising:
for separation of duty, expressing in linear logic each expression of authority of a plurality of expressions of authority;
receiving an access control request; and
determining whether access may be granted based on the linear logic.

18. The method of claim 17, further comprising:
consuming one expression of authority; and
indicating the other expressions of authority as consumed.

19. The method of claim 17, further comprising granting access if each expression of authority is unconsumed.

20. The method of claim 17, wherein each expression of authority is expressed as an implication in the linear logic.
